(19) United States
(12) Patent Application Publication
(10) Pub. No.: US 2003/0198766 A1
(43) Pub. Date: Oct. 23, 2003

(54) Seat cushion having blade - proof and bullet - proof function

(76) Inventor: Masayuki Ezoe, Funabashi-shi (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/125,388

(22) Filed: Apr. 19, 2002

(51) Int. Cl. B32B 1/02

(52) U.S. Cl. 428/36.1

(57) ABSTRACT

A seat cushion for self-defense equipped with a blade-proof and bullet-proof function that is handy and free from annoyance seen in such self-defense items as required to be always attached to one's body and serves as a shield against a criminal act. The seat is constituted by laminating a single layer through three layers of structures each composed of a combination of a cushion material layer used for constituting an ordinary seat cushion and a fabric laminated body layer laminated a woven fabric constituted by a high strength fiber having a tensile strength equal to or more than 20 g/d, encapsulating the laminated structures by a cushion material, and covering the encapsulated structure by an outer skin constituting the seat cushion.

### BACKGROUND OF THE INVENTION

1. Field of the Invention

The present invention relates to a seat cushion for self-defense equipped with a blade-proof and bullet-proof function that is handy and free from annoyance seen in such self-defense items as required to be always attached to one's body, and serves as a shield against a criminal act.

2. Description of the Related Art

For self-defense against a criminal act, a bullet-proof vest has been developed which comprises a high strength fiber such as a high density woven fabric constituted of aramid fiber, e.g., polyparaphenylene terephthalamide; high molecular weight polyethylene fiber; or polyparaphenylene benzobisoxazole fiber. The bullet-proof vest is excellent in bullet-proof function, compared with that of a metal plate, and also excellent in wearability.

As seen in JP-B-58449/1993, JP-B-50243/1991, JP-A-188654/1996, or JP-A-514543/2000, such bullet-proof vest has constituted of a sheet-like material having a structure (UD structure) where the high strength fibers are arranged in a matrix resin substantially in parallel along the same direction. The function of the vest is highly evaluated.

The afore-mentioned bullet-proof vest however is mainly used for the person in a task under a unusual condition such as dangerous situation as being fired by a gun or being stabbed often seen in the case of arresting brutal criminals, suppressing riot, or escorting VIP or important articles; and not for an ordinary person in daily life.

Recently, public security in our country has been endangered more and more, threatening not only persons at a dangerous task such as arresting brutal criminals, suppressing riot, or escorting VIP or important articles, but also employees who handle cash in a financial agency, a supermarket, a convenience store, a pinball prize exchanging counter and who carries cash by a car. In their routine work, however, those ordinary person cannot always attach said protective items such as blade-proof and bullet-proof vest to themselves. Under the circumstance, self-defense items that realize a security against said crimes is strongly demanded that is effective in enabling to protect the body in case of emergency, provide chances of emergency call, and have high protective function, as well as being a handy and ordinarily used article.

Through various investigation for an ordinary article that satisfies handy and user-friendly characters and yet can afford to be equipped with a member having a blade-proof and bullet-proof function, the inventors have found that all the necessary conditions could be satisfied by a seat cushion. Accordingly, they conceived that the member having the blade-proof and bullet-proof function should be built inside of a seat cushion.

Incidentally, there are a futon, a seat cushion, a pad, and a blanket each constituted of aramid fibers, described in JP-A Nos. 110393/1989, 26975/1990, 261412/1991, 94168/1991. Note that those are a fireproof futon, a fireproof seat cushion, a fireproof blanket, respectively, and are the ones that utilize the fireproof property of the aramid fiber, and have not any relation with the present invention, purpose of which is blade-proof and bullet-proof. Also those are the different ones from the standpoint of the thought, the object, the effect, and the constitution of the present invention.

### SUMMARY OF THE INVENTION

The present invention provides a seat cushion having a constitution described in claims and has succeeded in solving the problem by using the seat cushion as a protective member. Namely:

1. The invention is applied to a seat cushion having a blade-proof and bullet-proof function formed by:

laminating a single layer through three layers of structures, each comprising a combination of a cotton wadding or a cushion material layer used for constituting the seat cushion and a fabric laminated body layer laminated with a plurality of sheets of woven fabrics constituted by a high strength fiber having a tensile strength equal to or more than 20 g/d;

arranging a cotton wadding or a cushion material layer used for constituting the seat cushion at an uppermost layer and a lowermost layer of the laminated structures; and

covering the structures by an outer skin for constituting the seat cushion.

2. There is provided a seat cushion having a blade-proof and bullet-proof function including a structure as set forth in claim 1, in which there are 100 to 400 g/m² as to a unit weight of the woven fabric constituted by the high strength fiber specified in claim 1, there are 6 to 15 layers as to the number of laminated layers laminated with the woven fabric to constitute the woven fabric laminated body, and intervals among the layers of the woven fabric constituting the woven fabric laminated body are quilted or bonded by spots.

3. There is provided a seat cushion having a blade-proof and bullet-proof function including a structure as set forth in either of claim 1 or claim 2, in which the fabric laminated body layer is laminated with the woven fabrics by successively shifting an aligning direction of a constituent fibers of the woven fabric by 45° in a weave structure constituting the woven fabric.

4. There is provided a seat cushion having a blade-proof and bullet-proof function including a structure as set forth in any one of claims 1 to 3 in which the high strength fiber is an aramid fiber.

By applying the seat cushion described above as a protecting member, an object of the invention has been successfully achieved.

Hereinafter, a content of a constitution of the invention and an effect based thereon will now be described in more detail.

(1) The seat cushion of the invention is not different from the conventional seat cushion in appearance. Thus the seat cushion is suitable for the person at jobs, ordinary but possibly to be put in danger, such as to handle cash in a financial agency e.g. banks, supermarket, or convenience store, and taxi. The seat cushion also is handy and free from annoyance seen in such self-defense items as required to be always attached to one's body. With those characters, the cushion seat has a blade-proof and bullet-proof function that serves as a shield against a criminal act and can afford to provide chances of emergency call.

(2) The seat cushion as specified in the claim 1 is basically formed by:

laminating a single layer through three layers of structures each comprising a combination of fabric laminated body layers laminated with a plurality of sheets of woven fabrics constituted by high strength fibers having a tensile strength equal to or more than 20 g/d, in which a blade-proof and bullet-proof function of a blade-proof vest constituting member has already been verified, and a cushion material layer used for constituting the seat cushion effective in absorbing impact at the time of being shot;

arranging a cotton wadding or a cushion material layer used for constituting the seat cushion at a topmost and a bottommost layers of the laminated structures; and

covering thus formed structures by an outer skin for constituting the seat cushion.

The seat cushion is thus excellent in the blade-proof and bullet-proof function.

The seat cushion has an another advantage a body-attached type self-defense item such as the bullet-proof has not. The bullet-proof vest, because of its blade-proof and bullet-proof layer composed of a fabric laminated body layer of a high strength fiber, is effective in preventing a bullet or a cutting blade from damaging one's body. But the vest can not cover the deformation and impact locally applied to the body. The seat cushion solves the problem by its cushion and by a use in a way of not-directly-attached to one's body.

(3) A constitution requirement specified in claim 2 defines a typical constitution requirement desired to achieve the function by the blade-proof and bullet-proof seat cushion specified in claim 1 and as general necessary conditions making the functions to achieve to the maximum, there are items as described below.

a. A unit weight of a woven fabric constituted by the high strength fibers is 100 to 400 g/m², and the woven fabric laminated body is a fabric laminated body layer having the number of laminated sheets of 6 to 15 layers.

b. In order to disperse stress applied on the shot portion and to absorb and disperse energy effectively, intervals among woven fabric layers of the fabric laminated body layer laminated with a plurality of sheets of the woven fabrics constituted by the high strength fiber are set in a state of not being bonded or fixed and the intervals are quilted or bonded at spots at intervals equal to or more than 50 mm, which is effective.

(4) A constitution requirement specified in claim 3 defines a typical constitution requirement desired for the blade-proof and bullet-proof seat cushion specified in claim 1 and claim 2. As a general necessary condition making the seat cushion to achieve functions to the maximum, the fabric laminated body layers laminated with the plurality of sheets of the woven fabric constituted by the high strength fibers specified in claim 1 and claim 2 are laminated by shifting an aligning direction of a constituent fibers constituting the woven fabrics by 45° successively.

The reason is that when constituting woven fabrics are laminated by successively shifting the aligning direction of the constituent fibers by 45° into such a laminated state in which the blade-proof function becomes the maximum, since even when the laminate is cut by the cutting blade by any entry angle of blade, the number of cut pieces of the constituent fibers in the woven fabrics required for cutting and bringing the blade thereinto become the maximum. Namely, when the woven fabrics having fibers with the same aligning directions are laminated simply, there is a case where the number of the cut pieces thereof is increased to double depending on the entry angle of blade and a case where the number of the cut pieces is reduced in half and the blade-proof function cannot be achieved to the maximum. In the bullet-proof function, similar effect to the aforementioned cases can be observed.

(5) A specification in relation to the high strength fiber constituting the seat cushion having the blade-proof and bullet-proof function specified in any one of claim 1 to claim 3 is an aramid fiber as the representative example to be universal and easily usable.

Next, the high strength fibers used according to the invention will be described. Any fiber may be selected so far as the selected fiber has a tensile strength equal to or more than 20 g/d. The representative examples are an aramid fiber represented by such as polyparaphenylene terephthalamide, high molecular weight polyethylene fiber, carbon fiber, polyparaphenylene benzobisoxazole fiber (PBO), or a polyparaphenylene benzobistiazole fiber (PBT), and when the selected fiber is, so-to-speak, a high strength fiber on sale, any fiber is applicable.

Such a fiber may be used by being woven into a woven fabric using multifilament yarn or may be used after having been spun into spun yarn and woven thereinto.

As a weave structure constitution of the woven fabric, although not particularly restricted, it is preferable to have a comparatively simple weave structure constitution having a high weave density such as a plain weave or a twill weave.

As a weave structure constitution of the woven fabric, it is not necessarily desired to use a multiple woven fabric, which is said to have a high bullet-proof effect since the woven fabric avoids stress concentration and disperses stress when the woven fiber is shot by or cut, intervals among woven fabric layers of the fabric laminated body layers laminated with a plurality of sheets of the woven fabrics constituted by the high strength fibers are brought into a state of not being bonded or fixed and the woven fabric is preferably used in a state in which the intervals are quilted or bonded at spots at intervals equal to or more than 50 mm in order to provide the close contact performance.

Although not restricted particularly, quilting performed to provide the close contact performance of the woven fabric laminated body is preferably executed by using a high strength yarn the same as that made of the fiber constituting the woven fabric in order to be endurable to any high degree of impact by shooting.

Although not restricted or selected particularly as necessary conditions, when the blade-proof and bullet-proof seat cushion is constituted by the woven fabrics with the same unit weight, in the blade-proof and bullet-proof seat cushion of the invention and from the view point of the blade-proof and bullet-proof function, the number of the laminated structures each composed of a combination of the cushion material layer constituting the seat cushion and the fabric laminated body layer laminated with a plurality of sheets of the woven fabrics constituted by the high strength fibers is set to be plural rather than single, which is recommendable since the blade-proof and bullet-proof function can be enhanced.

Although not specified particularly as necessary conditions, the entire laminated bodies of a plurality of layers of the structures each composed of a combination of the cushion material layers specified in this invention and the fabric laminated body layers provided with the close contact performance after laminating the plurality of sheets of the woven fabrics constituted by the high strength fiber and by quilting or bonding at spots is integrally formed by quilting with a coarse interval of stitch, which is preferable in order to enhance the blade-proof and bullet-proof function.

A specific manufacturing method and a constituting state of the seat cushion having the blade-proof and bullet-proof function according to the invention will be described below. That is:

In a seat cushion F having the blade-proof and bullet-proof function and as illustrated in a constituting state thereof in FIG. 2, there is laminated 6 to 15 sheets of a woven fabric 1 (although not particularly limited in a weave structure constituting the woven fabric, a plain weave or twill weave is suitable) having a unit weight of 100 to 400 g/m², woven by using the high strength fiber (may be filament yarn or spun yarn) having the tensile strength equal to or more than 20 g/d, intervals among the layers of the woven fabric are quilted for providing the close contact performance therebetween or bonded at spots at intervals of points of bonding equal to or more than 50 mm after applying a hot-melt adhesive in a spot shape on each surface of the woven fabric such that the respective intervals of the points of bonding is equal to or more than 50 mm, and a woven fabric laminated body A loosely laminated and integrally formed by a plurality of sheets of the woven fabrics is manufactured.

At this time, a laminated state of the woven fabric constituting the woven fabric laminated body A may be laminated by aligning an fiber aligning direction constituting the woven fabric or by successively shifting the aligning direction by 45°, however, in order to provide higher blade-proof and bullet-proof function, it is preferable to laminate the woven fabrics by successively shifting the aligning direction by 45° Next, a structural body B is constituted by laminating the woven fabric laminated body A and a cushion material 2 used as a cushion material for the seat cushion such as a cushion material composed of cotton wadding, synthetic staple fiber wadding, or other foaming body with a thickness of 5 to 20 mm, a single layer through three layers of the structural bodies B are further laminated, which is further encapsulated by a cushion material 3 for constituting the seat cushion, which is further covered by an outer skin (such as woven fabric, leather) and the blade-proof and bullet-proof seat cushion of the invention is constituted.

It will give a preferable result to a structure formed of a structural body B or a structure encapsulating the structural body B by the cushion material to apply quilting also with at further coarse interval of stitch for the purpose of improving the blade-proof and bullet-proof effect.

As illustrated in FIG. 3, in order to make it easy to use for protecting body in emergency, handles 5 may be provided on a rear face of the seat cushion F.

### BRIEF DESCRIPTION OF THE DRAWINGS

FIG. 1 is a view of a kitchen knife used for evaluating a blade-proof function;

FIG. 2 is a sectional view illustrating a state constituting a blade-proof and bullet-proof seat cushion; and

FIG. 3 is a plan view illustrating a rear face of the blade-proof and bullet-proof seat cushion.

### DESCRIPTION OF THE PREFERED EMBODIMENTS

Hereinafter, by embodiments, a constituting state and an effect of a seat cushion having a blade-proof and bullet-proof function according to the invention will be further specifically described as follows.

### EXAMPLE 1

A twill woven fabric 1 having a weave density of 59 pieces per inch of vertical yarns and 47 pieces per inch of horizontal yarns and a unit weight of 300 g/m² is woven by using spun yarn of a yarn count 20/2 constituted by a polyparaphenylene terephthalamide fiber (product of TEIZIN K.K.), that is, a staple fiber of Kevlar129 (tensile strength 26.5 g/d, and modulus of elasticity in tension 760 g/d). Representative physical properties of an obtained woven fabric are shown in Table 1.

TABLE 1

| | | Percentage | | | |
|---|---|---|---|---|---|
| | | Elongation | | | |
| | Tensile | after | Tearing | | Shrinkage |
| | Strength | Fracture | Strength | Bursting | Percentage |
| | Kgf | % | Kgf | Strength | % |
| Vertical | 248 | 12.7 | 51.5 | 59.8 | 0 |
| Yarn | | | | | |
| Horizontal | 210 | 9.3 | 57.3 | Kgf/cm² | 0 |

(Notes)
Physical properties are measured according to JIS L 1096 by a general woven fabric testing method.

Values of the tensile strength are measured according to an A method (strip method), constant speed elongation type for a width of a test sample 2.5 cm, values of the tearing strength are measured according to an A-1 method (single tong method), and values of the bursting strength are measured according to an A method (Mühlen type method).

10 sheets of the woven fabric 1 thus obtained are laminated by aligning the woven fabric in a fiber aligning direction to thereby constitute a woven fabric laminated body A, in order to provide close contact performance, quilting is performed at intervals of 50 mm both in directions of vertical yarns and horizontal yarns by spun yarn of a yarn count 20/2 the same as that of an aramid fiber spun yarn of the woven fabric.

Successively, there is laminated a cushion layer 2 for absorbing impact comprising a cotton wadding layer having a thickness of 6 mm on a bottom face of the quilted woven fabric laminated body A to thereby produce a structural body B laminated with two layers of the laminated body A and layer 2.

In the woven fabric laminated body A constituting the structural body B, by using a woven fabric laminated body A′ changing only the number of laminated sheets of woven fabric to six, a structural body B′ of a constitution the same as that of the body B is formed, the obtained body B (upper side) and the body B′ (lower side) are laminated with each other. Further, quilting is performed at respective intervals of 150 mm both in directions of vertical yarns and horizontal yarns and loosely and integrally formed, which is cut to a dimension (50 to 60 cm square) suited to constitute the seat cushion, which is encapsulated by a cotton wadding layer 3 by a thickness of 10 mm, which is further covered by an outer skin (cloth piece) 4 for constituting the seat cushion (entire thickness 40 mm), to thereby produce the blade-proof and bullet-proof seat cushion.

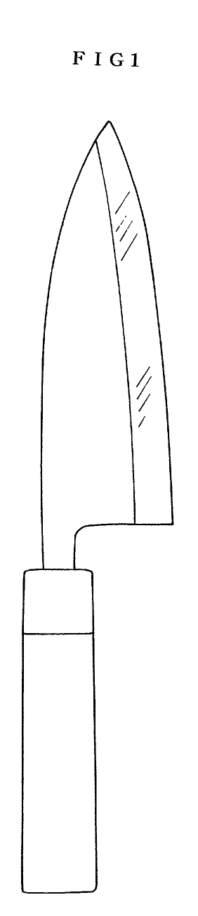

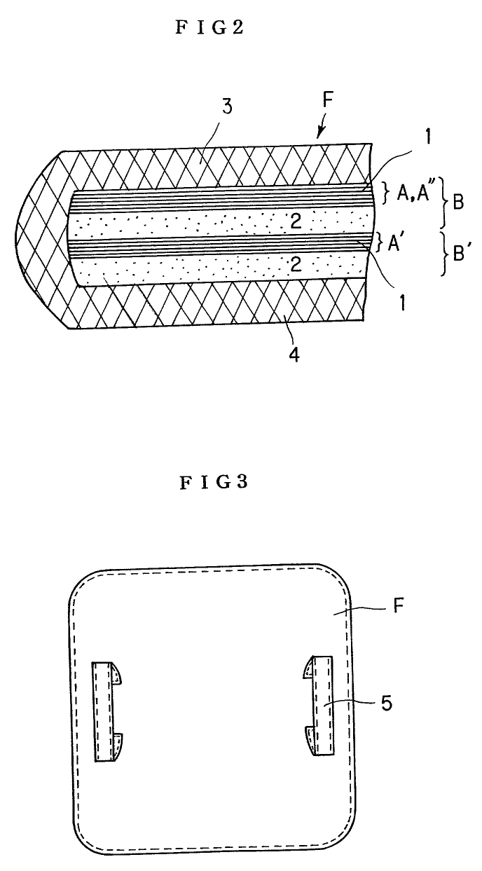

In order to evaluate a blade-proof function of the produced blade-proof and bullet-proof seat cushion, as illustrated in FIG. 1, the seat cushion is placed on a lauan plate having a thickness 65 mm, a sharp kitchen knife made of steel, having a total length of 265 mm, a blade length of 140 mm, a wall thickness at a back blade portion of 7 mm, a weight of 190 g is set at a position of 3.7 m above the seat cushion and is dropped towards the blade-proof and bullet-proof seat cushion (body to be tested), a state of stabbing the kitchen knife into the seat cushion serving as the body to be tested is observed to thereby evaluate the blade-proof function of the blade-proof and bullet-proof seat cushion.

An observation result of the blade-proof function of the produced blade-proof and bullet-proof seat cushion is that a blade tip of the kitchen knife is in a state of being pierced into the woven fabric through at a tenth layer of the laminated body A constituting the tested seat cushion only by a small amount (protruded by 0. 1 mm), a cushion material layer of the structural body B is not substantially impaired, the structural body B′ of the lower side is not impaired at all, which shows that the seat cushion has the sufficient blade-proof function.

### EXAMPLE 2

Only a laminating method of the woven fabric laminated body A is changed in manufacturing the blade-proof and bullet-proof seat cushion described in Example 1. There is manufactured a woven fabric laminated body A″ laminated by shifting the aligning directions of the fibers constituting the woven fabric successively by 45°. The laminated body A″ is used in place of the laminated body A in Example 1, and other constitution is quite the same as that of Example 1, to thereby produce a blade-proof and bullet-proof seat cushion of the same constitution for evaluating the blade-proof function similar to Example 1.

A result of the evaluation is that although the blade-proof and bullet-proof seat cushion of Example 2 is excellent similar to that of Example 1, however, is different from that of Example 1 according to the woven fabric laminating method of the laminated body A″ constituting the seat cushion, since the fiber aligning direction constituting the woven fabric constituting the laminated body A″ is laminated to shift successively by 45° for respective layer, further since the number of fibers to be cut and a cutting resistance increase when a cutting tip of the blade penetrates the tested seat cushion, a resistance against penetrating the seat cushion increases, the cutting edge of the kitchen knife cuts a seventh layer of the laminated body A″ constituting the tested seat cushion by only a small amount, sheets including an eighth layer thereof are not impaired at all, which shows that the seat cushion has excellent blade-proof function.

### EXAMPLE 3

There is produced a woven fabric (300 g/m²) of a plain weave woven by a density of 90 pcs/cm of vertical and horizontal yarns using a multifilament yarn of 1,500 d/1,000 f of polyparaphenylene benzobisoxazole fiber (PBO) having a tensile strength: 40 g/d, a modulus of elasticity in tension 2,000 g/d, a percentage elongation after fracture 2.5%, and by using the woven fabric, a blade-proof and bullet-proof seat cushion having a content and a constitution the same as those of Example 2 is produced in place of the aramid fiber woven fabric in Example 2.

In order to evaluate a blade-proof function of the blade-proof and bullet-proof seat cushion, the seat cushion is fixed onto a plate of lauan material having a thickness of 65 mm to prevent positional shift, a 9 mm handgun is set so that a bullet hits the seat cushion perpendicularly at a distance 5 m from a muzzle thereof, the bullet is discharged, thereafter the shot seat cushion is disassembled, and a state of penetrating the bullet is visually observed for evaluating the bullet-proof function.

Results of evaluating the bullet-proof function visually performed on the disintegrated object by observing a cut surface in a bullet penetrating direction of a shot portion in the shot seat cushion and a peeled object in a laminated direction of the shot seat cushion are that rupture of the woven fabric caused by penetrating the bullet through the fabric laminated body A″ layer is more completely and definitely observed as the woven fabric is present in a higher layer, a state of rupture is less observed in the layers including the eighth layer, and no rupture is observed in the woven fabric of the tenth layer. However, displacement of the weave structure caused by the bullet is clearly observed, therefore it has been revealed that although the bullet can be prevented from penetrating the seat cushion by the laminated body A″ layer, the displacement caused thereby cannot be prevented yet.

Since the displacement of the weave structure due to intrusion of the bullet seems to be absorbed by the cushion layer of the structural body B, the slight deformation and displacement of the weave structure are caused to the woven fabric up to the third layer of the fabric laminated body layer A′ disposed at an upper face of the structural body B′. In the woven fabric layer including the fourth layer, however, substantially no deformation and displacement of the weave structure are observed, and it has been found that the impact by the shot bullet is substantially checked.

Naturally, no dent is observed in the lauan plate at the back side of the seat cushion.

In evaluating the blade-proof function of the blade-proof and bullet-proof seat cushion conducted similar to Example 1, the cutting tip of the kitchen knife cuts slightly the woven fabric of the sixth sheet of the laminated body A″ in the body B constituting the tested seat cushion and woven fabrics of layers including the seventh sheet are not impaired at all. Thus the seat cushion of Example 3 is found to be considerably excellent.

### COMPARATIVE EXAMPLE

A normal seat cushion composed only of the cotton wadding as cushion material having a thickness of 70 mm is produced, a blade-proof function test and a bullet-proof function test are carried out. In the former test the cutting tip of the kitchen knife penetrates the seat cushion and pierces the lauan plate up to a depth of 9 mm.

In the latter test, the bullet pierces deeply the lauan plate, since the seat cushion is not provided with a bullet-proof function.

In using the blade-proof and bullet-proof seat cushion of the invention, the seat cushion can be used with no difference from a normal seat cushion used daily close at hand, without feeling trouble of wearing, oppression by wearing, and hamper of activity experienced in wearing a bullet-proof vest. Activity can be carried out under normal wear, and in emergency it is possible to produce an environment and state of protecting the body against any damage by being shot or stabbed by constituting the seat cushion as a protective member (shield).

Since such a blade-proof and bullet-proof seat cushion is used as a shield by holding the seat cushion before the body in emergency, there is resolved a problem that although penetration of the bullet can be evaded in the case of such as the bullet-proof vest, deformation and impact of the bullet-proof vest caused by being shot is hardly avoided, and while preventing a danger with composure, search for rescue can also be carried out.

What is claimed is:

1. A seat cushion having a blade-proof and bullet-proof function, formed by:
laminating a single layer through three layers of structures each comprising a combination of a cotton wadding or a cushion material layer used for constituting the seat cushion and a fabric laminated body layer laminated with a plurality of sheets of woven fabrics constituted by a high strength fiber having a tensile strength equal to or more than 20 g/d;
arranging a cotton wadding or a cushion material layer used for constituting the seat cushion at an uppermost layer and a lowermost layer of the laminated structures; and
covering the structures by an outer skin for constituting the seat cushion.

2. A seat cushion having a blade-proof and bullet-proof function as set forth in claim 1, wherein
a unit weight of the woven fabric constituted by said high strength fiber is 100 to 400 g/m², and intervals among the layers of the woven fabric laminated body laminated with 6 to 15 layers of said woven fabrics are quilted or bonded by spots.

3. A seat cushion having a blade-proof and bullet-proof function as set forth in either of claims 1 or 2, wherein
said fabric laminated body layer is laminated by the woven fabrics by successively shifting an aligning direction of a constituent fibers of the woven fiber by 45° in a weave structure constituting the woven fabric.

4. A seat cushion having a blade-proof and bullet-proof function as set forth in any of claims 1 to 3, wherein said high strength fiber is an aramid fiber.

5. A seat cushion having a blade-proof and bullet-proof function as set forth in any of claims 1 to 4, wherein handles are provided on a rear face of said seat cushion.
